(19) United States
(12) Patent Application Publication
(10) Pub. No.: US 2009/0167419 A1
(43) Pub. Date: Jul. 2, 2009

(54) Voltage converting circuit

(75) Inventor: Makoto Sakaguchi, Shiga (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/314,980

(22) Filed: Dec. 19, 2008

(30) Foreign Application Priority Data
Dec. 28, 2007 (JP) 2007-340531

(51) Int. Cl. G05F 1/10

(52) U.S. Cl. 327/536

(57) ABSTRACT

Leakage current flowing into load is prevented when a charge pump circuit operation is halted. The charge pump circuit converts supply voltage, supplied to a supply-voltage input terminal, to an output signal having desired voltage value and outputs the signal to an output terminal. A first bypass circuit, connected between the supply-voltage input terminal and a supply node of the charge pump circuit, forms a bypass between the supply-voltage input terminal and the supply node only when a voltage value at the supply node is low compared with a supply voltage value supplied to the supply-voltage input terminal. A second bypass circuit connected between the output terminal and the supply node, forms a bypass between the output terminal and the supply node only when the voltage value at the supply node is low compared with the voltage value at the output terminal.

### REFERENCE TO RELATED APPLICATION

This application is based upon and claims the benefit of the priority of Japanese patent application No. 2007-340531, filed on Dec. 28, 2007, the disclosure of which is incorporated herein in its entirety by reference thereto.

### FIELD OF THE INVENTION

This invention relates to a voltage converting circuit and, more particularly, to a voltage converting circuit for boosting supply voltage to a desired voltage using a charge pump circuit, and a semiconductor device comprising same.

### BACKGROUND

A voltage converting circuit is used to extract an output voltage from a single supplied voltage, wherein the value of the output voltage is larger or smaller than the supplied voltage. In cases where such a voltage converting circuit is contained in a semiconductor integrated circuit or the like, extensive use is made of a charge-pump-type voltage converting circuit.

A charge-pump-type voltage converting circuit boosts output voltage from 0 V to a desired output voltage value by repeated switching. Since output voltage is boosted from 0 V at start-up, a problem which arises is that it takes time for the output voltage to attain and stabilize at the desired output voltage value.

Accordingly, Patent Document 1 discloses a voltage converting circuit that makes it possible to raise the efficiency with which the output voltage attains the desired voltage value. FIG. 5 is a diagram illustrating the configuration of a voltage converting circuit according to the prior art. As shown in FIG. 5, the voltage converting circuit includes a diode D101 connected between a supply voltage input terminal 101 that provides the supply voltage and an output terminal VOUT of a charge pump circuit 30. In accordance with the supply voltage value supplied to the charge pump circuit 30 and the voltage value of the output signal from the charge pump circuit 30, the diode D101 bypasses the supply voltage to the output terminal VOUT in a case where the voltage value Vout of the output signal is lower than the supply voltage value Vcc. It should be noted that a capacitor C101 connected to the charge pump circuit 30 is a charging capacitor, and that a capacitor C102 is an output smoothing capacitor.

By thus causing the supply voltage Vcc to be bypassed to the output voltage Vout by the diode D101 in a case where the output voltage Vout is below the supply voltage Vcc in this voltage converting circuit, rise time at which the output voltage Vout reaches the desired voltage value from 0 V can be shortened.

[Patent Document 1] Japanese Patent Kokai Publication No. JP-P2003-164142A

### SUMMARY OF THE DISCLOSURE

The entire disclosure of Patent Document 1 is incorporated herein by reference thereto.

The following analysis has been made in view of the present invention.

In recent electronic devices, especially portable electronic devices, battery duration of an installed battery is one vital required characteristic. For this reason, the circuitry within such an electronic device is equipped with a feature such as a power saving mode.

In a case where the load circuit (not shown) connected downstream of the output terminal VOUT is made to perform a low current consuming operation such as that of a power saving mode, a voltage equivalent to Vcc−Vf (the forward voltage drop of the diode D101) is impressed upon the output terminal VOUT via the bypass diode D101 even if the charge pumping operation is halted. As a consequence, leakage current flows into the load circuit connected downstream of the output terminal VOUT.

By way of example, assume that serially connected resistors R1, R2 (to the midpoint of which a voltage-follower amplifier AMP has been connected) of the kind shown in FIG. 6 have been connected as the load of a charge pump circuit. In this case, usually a switch element such as a FET is inserted in series with the resistors R1, R2 and the current path is interrupted thereby so that a current will no longer flow in order that power may be saved. However, if the bias at the midpoint of the resistors R1, R2 is required to be accurate, the switch element for interrupting the current path cannot be inserted. The reason is that voltage precision declines owing to a variation in the resistance value of the switch element. Since the resistors R1, R2 are constantly connected as the load of the charge pump circuit in such case, a current flows through the resistors R1, R2. Thus there is much to be desired in the art.

According to a first aspect of the present invention, there is provided a voltage converting circuit comprising: a charge pump circuit that converts supply voltage supplied to a supply-voltage input terminal to an output signal of a desired voltage value and outputs the signal to an output terminal; a first bypass circuit which is connected between the supply-voltage input terminal and a (power) supply node of the charge pump circuit, and forms a bypass between the supply-voltage input terminal and the supply node only in a case where a voltage value at the supply node is closer to ground voltage in comparison with a supply voltage value supplied to the supply-voltage input terminal; and a second bypass circuit which is connected between the output terminal and the supply node, and forms a bypass between the output terminal and the supply node only in a case where the voltage value at the supply node is closer to ground voltage in comparison with the voltage value at the output terminal.

The meritorious effects of the present invention are summarized as follows.

In accordance with the present invention, leakage current that flows into the load when operation of the charge pump circuit is halted can be prevented by the second bypass circuit.

Other features and advantages of the invention will be apparent from the following description taken in conjunction with the accompanying drawings, in which like reference characters designate the same or similar parts throughout the figures thereof.

### BRIEF DESCRIPTIONS OF THE DRAWINGS

FIG. 1 is a circuit diagram illustrating the configuration of a voltage converting circuit according to a first exemplary embodiment of the present invention;

FIG. 2 is a circuit diagram in which bypass circuits are composed of diodes;

FIG. 3 is a circuit diagram of a level shifter;

FIG. 4 is a diagram illustrating waveforms of signals in the level shifter;

FIG. 5 is a circuit diagram illustrating the configuration of a voltage converting circuit according to the prior art; and

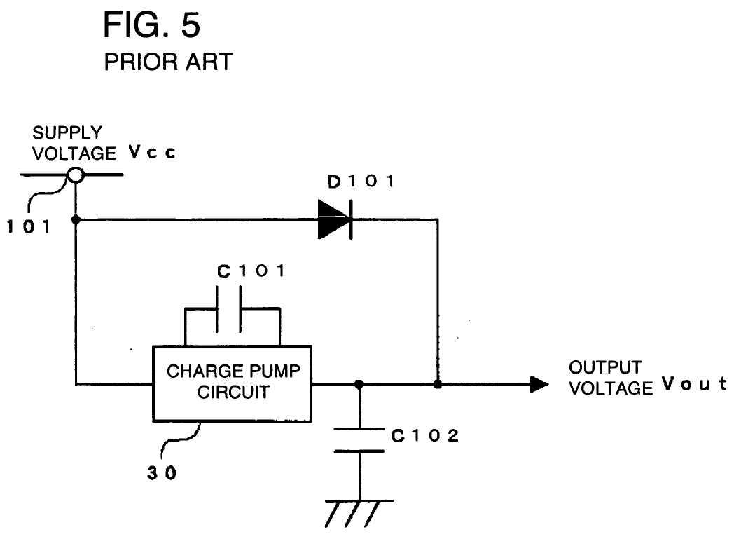

FIG. 6 is a circuit diagram illustrating an example of a load circuit according to the prior art.

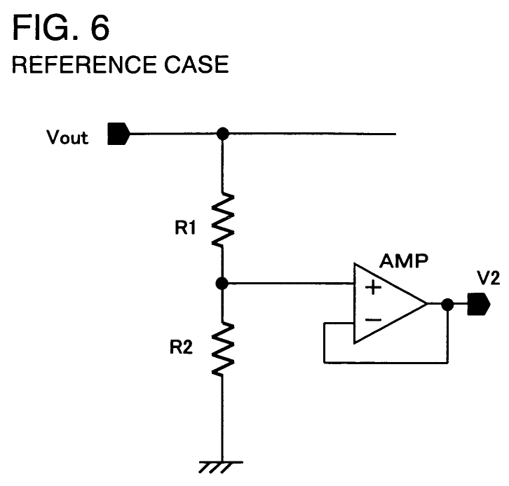

### PREFERRED MODES OF THE INVENTION

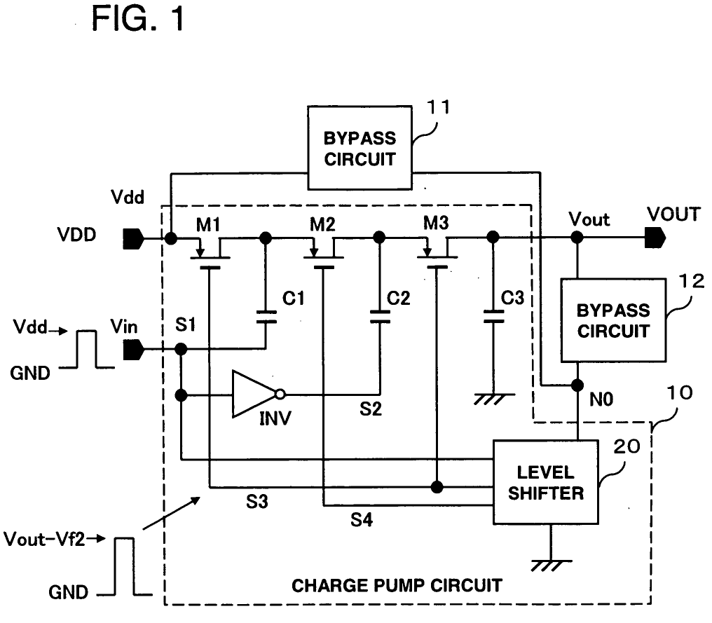

A voltage converting circuit according to a first mode of the invention includes a charge pump circuit 10 (FIG. 1), a first bypass circuit 11 (FIG. 1) and a second bypass circuit 12 (FIG. 1). The charge pump circuit converts supply voltage, which is supplied to a supply-voltage input terminal VDD (FIG. 1), to an output signal having desired voltage value and outputs the signal to an output terminal VOUT (FIG. 1). The first bypass circuit, which is connected between the supply-voltage input terminal and a (power) supply node N0 (FIG. 1) of the charge pump circuit, for forming a bypass between the supply-voltage input terminal and the supply node only in a case where a voltage value at the supply node is closer to ground voltage in comparison with a supply voltage value supplied to the supply-voltage input terminal. The second bypass circuit, which is connected between the output terminal and the supply node, for forming a bypass between the output terminal and the supply node only in a case where the voltage value at the supply node is closer to ground voltage in comparison with the voltage value at the output terminal.

In the voltage converting circuit of the first mode of the present invention, the supply voltage may be a positive voltage and the first bypass circuit may be constituted by a first diode having an anode terminal connected to the supply-voltage input terminal and a cathode terminal connected to the supply node. The second bypass circuit may be constituted by a second diode having an anode terminal connected to the output terminal and a cathode terminal connected to the supply node. (mode 2)

In the voltage converting circuit of the first mode of the present invention, the supply voltage may be a negative voltage and the first bypass circuit may be constituted by a first diode having a cathode terminal connected to the supply-voltage input terminal and an anode terminal connected to the supply node. The second bypass circuit may be constituted by a second diode having a cathode terminal connected to the output terminal and an anode terminal connected to the supply node. (mode 3)

In accordance with the voltage converting circuit (or semiconductor device) described above, the rise characteristic is improved by the first bypass circuit and leakage current that flows into the load when operation of the charge pump circuit is halted can be prevented by the second bypass circuit.

Following modes are further possible in the present invention.

The first bypass circuit may comprise a MOSFET which is diode-connected, and the second bypass circuit comprises a MOSFET which is diode-connected, instead of the diode, respectively. (mode 4)

The level shifter may control one or more transistors connected between the supply-voltage input terminal and the output terminal so as to make up a charge pump circuit. (mode 5)

The level shifter may be formulated so as to provide at least two levels of output signals for controlling the transistor(s) in accordance to a supply voltage at the supply node. (mode 6)

There is also provided a semiconductor integrated circuit comprising the voltage converting circuit as aforementioned. (mode 7)

Exemplary embodiments of the present invention will now be described in detail with reference to the drawings.

### FIRST EXEMPLARY EMBODIMENT

FIG. 1 is a circuit diagram illustrating the configuration of a voltage converting circuit according to a first exemplary embodiment of the present invention. As shown in FIG. 1, the voltage converting circuit includes the charge pump circuit 10, bypass circuits 11, 12, supply-voltage input terminal VDD, output terminal VOUT and a control input terminal Vin. Further, the charge pump circuit 10 includes a Pch transistor M1 serving as a first switch, a Pch transistor M2 serving as a second switch, a Pch transistor M3 serving as an output switch, a first charging capacitor C1, a second charging capacitor C2, a smoothing capacitor C3, a level shifter 20 and an inverter circuit INV.

The supply-voltage input terminal VDD is externally provided with a low-voltage supply voltage Vdd and is connected to the source of the Pch transistor M1. The control input terminal Vin, to which a signal S1 for driving the charge pump circuit 10 is externally applied, is connected to a first end of the capacitor C1, the input end of the inverter circuit INV and the level shifter 20. The Pch transistor M1, which has a gate to which a signal S3 that is output from the level shifter 20 is applied, has a drain connected to a second end of the capacitor C1 and to the source of the Pch transistor M2. The Pch transistor M2, which has a gate to which a signal S4 that is output from the level shifter 20 is applied, has a drain connected to a second end of the capacitor C2 and to the source of the Pch transistor M3. A signal S2, which is the result of inverting the signal S1, is applied to a first end of the capacitor C2 from the output end of the inverter circuit INV. The capacitor C3 has a first end connected to ground. The Pch transistor M3, which has a gate to which the signal S3 that is output from the level shifter 20 is applied, has a drain connected to a second end of the capacitor C3 and to the output terminal VOUT.

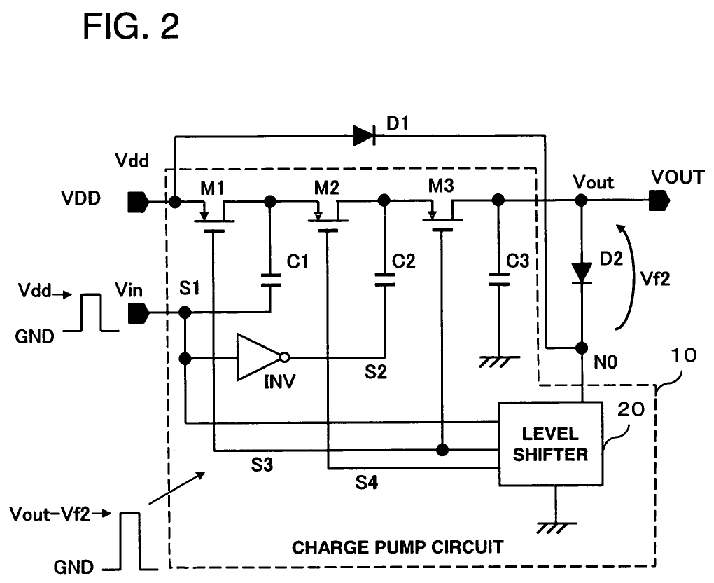

The first bypass circuit 11 has a first end connected to the supply-voltage input terminal VDD and a second end connected to a (power) supply node N0 of the level shifter 20. The bypass circuit 11 forms a bypass between the supply-voltage input terminal VDD and supply node N0 only in a case where the voltage value at the supply node N0 is low in comparison with the supply voltage value Vdd supplied to the supply-voltage input terminal VDD. As illustrated in FIG. 2, the bypass circuit 11 may be constituted by a diode D1 having an anode connected to the supply-voltage input terminal VDD and a cathode connected to the supply node N0. It should be noted that the bypass circuit 11 is not limited to a diode so long as it is a circuit that forms a bypass only in a case where the voltage value at the supply node N0 is low in comparison with the supply voltage value Vdd supplied to the supply-voltage input terminal VDD. For example, the bypass circuit 11 may just as well be a diode-connected MOSFET.

The second bypass circuit 12 has a first end connected to the output terminal VOUT and a second end connected to the supply node N0 of the level shifter 20. The bypass circuit 12 forms a bypass between the output terminal VOUT and supply node N0 only in a case where the voltage value at the supply node N0 is low in comparison with the voltage value Vout of the output terminal VOUT. As illustrated in FIG. 2, the bypass circuit 12 may be constituted by a diode D2 having an anode connected to the output terminal VOUT and a cathode connected to the supply node N0. It should be noted that the bypass circuit 12 is not limited to a diode so long as it is a circuit that forms a bypass only in a case where the voltage value at the supply node N0 is low in comparison with the voltage value Vout of the output terminal VOUT. For example, the bypass circuit 12 may just as well be a diode-connected MOSFET.

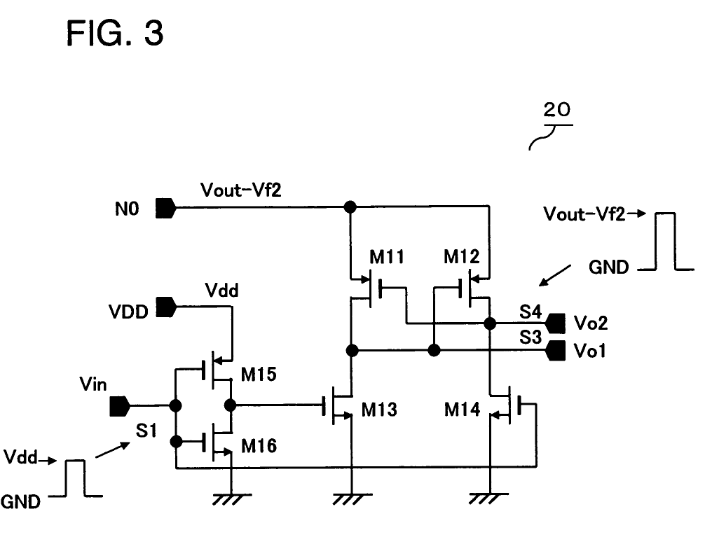

The level shifter 20 will be described next. FIG. 3 is a circuit diagram of an example of the level shifter 20. As shown in FIG. 3, the level shifter 20 includes the low-voltage supply-voltage input terminal VDD, the high-voltage supply node N0, the control input terminal Vin, an output signal terminal Vo1 for outputting the signal S3, an output signal terminal Vo2 for outputting the signal S4, a level-shift Pch transistor M11, a level-shift Pch transistor M12, a level-shift Nch transistor M13, a level-shift Nch transistor M14, an Pch transistor M15 for an input inverter and an Nch transistor M16 for the input inverter.

When the signal S1 that has entered from the control input terminal Vin is at the L level, the output of the inverter constructed by the Pch transistor M15 and Nch transistor M16 attains the H level. This voltage is approximately equal to the supply voltage value Vdd. Accordingly, the Nch transistor M13 to the gate of which the inverter output is connected turns on. Further, since signal S1 at the L level is applied to the gate of the Nch transistor M14, the Nch transistor M14 turns off. Since the Nch transistor M13 is on, the gate voltage of the Pch transistor M12 is pulled to ground level and the Pch transistor M12 turns on. On the other hand, since the Nch transistor M14 is off, the voltage of signal S4 at the output signal terminal Vo2 connected to the drain of the Nch transistor M14 rises to a level (Vout−Vf2) approximately the same as that at the supply node N0. Further, since the gate voltage of the Pch transistor M11 also rises to the voltage of the supply node N0, the Pch transistor M11 turns off and the Nch transistor M13 turns on. As a result, the voltage of signal S3 at the output signal terminal Vo1 connected to the drain of the Nch transistor M13 falls to ground level.

Conversely, when the signal S1 is at the H level, the output of the inverter constructed by the Pch transistor M15 and Nch transistor M16 falls to the L level. This voltage is approximately equal to the ground level. Accordingly, the Nch transistor M13 turns off. Further, since signal S1 at the H level is applied to the gate of the Nch transistor M14, the Nch transistor M14 turns on. Since the Nch transistor M14 is on, the gate voltage of the Pch transistor M11 is pulled to ground level and the Pch transistor M11 turns on. Since the Nch transistor M13 is off, the voltage of the output signal terminal Vo1 connected to the drain of the Nch transistor M13 rises to a level (Vout−Vf2) approximately the same as that at the supply node N0. Similarly, since the gate voltage of the Pch transistor M12 also rises to the voltage of the supply node N0, the Pch transistor M12 turns off and the Nch transistor M14 turns on. As a result, the voltage of signal S4 at the output signal terminal Vo2 connected to the drain of the Nch transistor M14 falls to ground level.

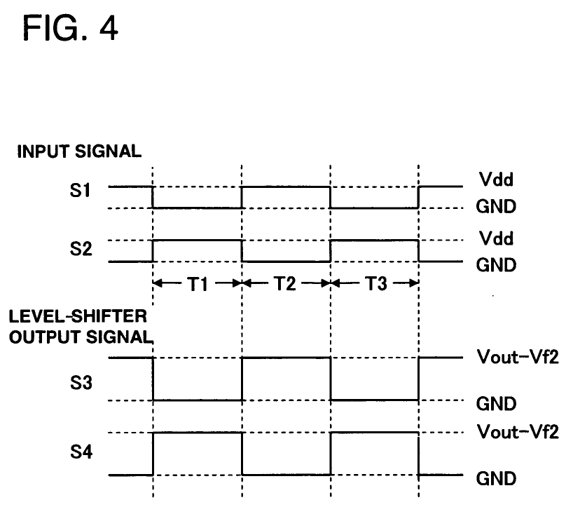

FIG. 4 is a diagram illustrating waveforms of the signals S1, S2, S3, S4 in the level shifter 20 that operates in the manner described above. The operation of the charge pump circuit 10 will be described in line with the time chart of FIG. 4.

First, in time period T1 of the operating waveforms in FIG. 4, when signal S1 is at the L level, signal S3 also is at the L level. The Pch transistor M1 therefore turns on, the capacitor C1 is charged from the supply-voltage input terminal VDD and the voltage across the terminals of the capacitor C1 becomes Vdd−α, where Vdd is the voltage value at the supply-voltage input terminal VDD and α represents each voltage drop by the ON resistances of the Pch transistors M1, M2, M3. At this time the signal S4 is at the H level (Vout-Vf2) and therefore the Pch transistor M2 is off.

In the next time period T2, signal S3 attains the H level (Vout−Vf2), the Pch transistor M1 turns off and the signal S4 is at the L level. The Pch transistor M2, therefore, turns on. Since signal S1 is at the H level, the electrode on the −(lower) side of the capacitor C1 is raised to Vdd, whereby the electrode on the +(upper) side of capacitor C1 is raised to Vdd+Vdd−α and capacitor C2 is charged to 2Vdd−2α by the voltage of the electrode on the +side of capacitor C1.

In the next time period T3, which is in the reverse state of time period T2, signal S4 is at the H level, Pch transistor M2 turns off, signal S3 is at the L level, Pch transistor M3 turns on and signal S2 attains the H level. Accordingly, the electric charge in capacitor C2 that has been charged to 2Vdd−2α flows into capacitor C3 through Pch transistor M3, capacitor C3 is charged to 3Vdd−3α and an output voltage Vout is output from the output terminal VOUT.

The foregoing operation is repeated so that the output voltage Vout continues to be output from the output terminal VOUT. The output voltage Vout becomes Vout=3Vdd−3α.

Further, the bypass diode D1 is connected between the supply-voltage input terminal VDD and the (power) supply node N0 of the level shifter 20. When the supply voltage Vdd rises, therefore, a voltage of Vdd−Vf is applied to the supply node N0 instantaneously, where Vf represents the forward voltage of the diode D1. As a result, the voltage Vdd−Vf is applied to the supply node N0 of the level shifter 20 from the moment the supply voltage Vdd rises. Accordingly, the amplitude of signals S3, S4 becomes Vdd−Vf from the moment the supply voltage Vdd rises, and the Pch transistors M1, M2, M3 are turned on by the voltage Vdd−Vf. That is, an output voltage Vout of the transistor M3 rises with ease even in a case where the load current is large to a certain extent.

Subsequently, the supply voltage to the level shifter 20 (the voltage at the supply node N0) becomes Vout−Vf2, where Vf2 is the forward voltage of the diode D2 for preventing reverse current. Consequently, although there is a possibility that the H-level voltage impressed upon the gates of the Pch transistors M1, M2, M3 might be lowered to be assumed a state where the FETs will not turn off completely, this problem can be solved by setting a threshold voltage at which the Pch transistors M1, M2, M3 turn on to a voltage greater than the forward voltage of the diode D2.

Now consider a case where a circuit downstream connected to the output terminal VOUT is made to perform a low-current consuming operation such as in a power saving mode. If the charge pumping operation has been halted, the voltage of Vdd−Vf from the supply-voltage input terminal VDD is applied upon the supply node N0 of the level shifter 20 by the diode D1. However, the diode D2 for preventing reverse current is disposed between the supply node N0 and the output terminal VOUT. Accordingly, all paths that can supply current to the output terminal VOUT are shut-off (become non-existent), the voltage Vout at the output terminal VOUT becomes approximately ground potential and there is no leakage of current to the circuit downstream.

It goes without saying that a circuit for outputting a negative output voltage can be constructed in similar fashion by reversing the polarities of all of the voltages in FIGS. 2 and 3, replacing the Pch transistors with Nch transistors, replacing the Nch transistors with Pch transistors and connecting the diodes in reverse.

Though the present invention has been described in accordance with the foregoing exemplary embodiments, the invention is not limited to these exemplary embodiments and it goes without saying that the invention covers various modifications and changes that would be obvious to those skilled in the art within the scope of the claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A voltage converting circuit comprising:
a charge pump circuit that converts supply voltage supplied to a supply-voltage input terminal to an output signal of a desired voltage value and outputs the signal to an output terminal;
a first bypass circuit which is connected between the supply-voltage input terminal and a supply node of said charge pump circuit, and forms a bypass between the supply-voltage input terminal and the supply node only in a case where a voltage value at the supply node is closer to ground voltage in comparison with a supply voltage value supplied to the supply-voltage input terminal; and
a second bypass circuit which is connected between the output terminal and the supply node, and forms a bypass between the output terminal and the supply node only in a case where the voltage value at the supply node is closer to ground voltage in comparison with the voltage value at the output terminal.

2. The circuit according to claim 1, wherein the supply voltage is a positive voltage;
said first bypass circuit comprises a first diode having an anode terminal connected to the supply-voltage input terminal and a cathode terminal connected to the supply node; and
said second bypass circuit comprises a second diode having an anode terminal connected to the output terminal and a cathode terminal connected to the supply node.

3. The circuit according to claim 1, wherein the supply voltage is a negative voltage;
said first bypass circuit comprises a first diode having a cathode terminal connected to the supply-voltage input terminal and an anode terminal connected to the supply node; and
said second bypass circuit comprises a second diode having a cathode terminal connected to the output terminal and an anode terminal connected to the supply node.

4. The circuit according to claim 1, wherein said first bypass circuit comprises a MOSFET which is diode-connected, and said second bypass circuit comprises a MOSFET which is diode-connected.

5. The circuit according to claim 1, wherein said level shifter controls one or more transistors connected between said supply-voltage input terminal and said output terminal so as to make up a charge pump circuit.

6. The circuit according to claim 5, wherein said level shifter is formulated so as to provide at least two levels of output signals for controlling said transistor(s) in accordance to a supply voltage at the supply node.

7. A semiconductor integrated circuit comprising said voltage converting circuit according to claim 1.
